(19) United States
(12) Patent Application Publication
(10) Pub. No.: US 2017/0094368 A1
(43) Pub. Date: Mar. 30, 2017

(54) INFORMATION PROCESSING APPARATUS AND METHOD FOR TRANSMITTING IMAGES

(71) Applicant: Yuushin KAKEI, Kanagawa (JP)

(72) Inventor: Yuushin KAKEI, Kanagawa (JP)

(73) Assignee: Ricoh Company, Ltd., Tokyo (JP)

(21) Appl. No.: 15/271,384

(22) Filed: Sep. 21, 2016

(30) Foreign Application Priority Data
Sep. 30, 2015 (JP) 2015-194989

(51) Int. Cl. H04N 21/61; H04N 21/44; H04N 21/442; H04N 21/2343

(52) U.S. Cl. CPC H04N 21/6125; H04N 21/234309; H04N 21/44008; H04N 21/44209

(57) ABSTRACT

An information processing apparatus includes an image converter configured to extract a plurality of vertices of an object in a raster image and at least one line connecting the plurality of vertices, and to convert the raster image into vector information expressed by information of the plurality of vertices and the at least one line; and a transmitter configured to transmit the vector information.

### CROSS-REFERENCE TO RELATED APPLICATION

The present application claims the benefit of priority under 35 U.S.C. §119 of Japanese Patent Application No. 2015-194989, filed on Sep. 30, 2015, the contents of which are incorporated herein by reference in their entirety.

### BACKGROUND OF THE INVENTION

1. Field of the Invention

The present invention relates to an information processing apparatus and a method for transmitting images.

2. Description of the Related Art

Display devices such as electronic whiteboards are used in offices and educational institutions, etc. The display device displays images on a display, and the user can draw characters and figures on the image.

Furthermore, there is known an image sharing technology, in which electronic whiteboards are connected to each other via a network, or an electronic whiteboard and a terminal such as a personal computer or a tablet, etc., are connected to each other via a network. The connected devices share image data, etc., in a real-time manner via the network.

Furthermore, there is known a technology of decreasing the resolution of the data such as images to be sent, to reduce the consumption amount of the bandwidth of a network (see, for example, Patent Document 1).

Patent Document 1: Japanese Unexamined Patent Application Publication No. 2015-089099

### SUMMARY OF THE INVENTION

An aspect of the present invention provides an information processing apparatus and a method for transmitting images in which one or more of the above-described disadvantages are reduced. According to one aspect of the present invention, there is provided an information processing apparatus including an image converter configured to extract a plurality of vertices of an object in a raster image and at least one line connecting the plurality of vertices, and to convert the raster image into vector information expressed by information of the plurality of vertices and the at least one line; and a transmitter configured to transmit the vector information.

### BRIEF DESCRIPTION OF THE DRAWINGS

Other objects, features and advantages of the present invention will become more apparent from the following detailed description when read in conjunction with the accompanying drawings, in which:

FIG. 1 is a diagram illustrating the entire configuration of an image sharing system according to an embodiment of the present invention;

FIG. 2 is a hardware block diagram of a terminal according to an embodiment of the present invention;

FIG. 3 is a hardware block diagram of an electronic whiteboard according to an embodiment of the present invention;

FIG. 4 is a functional block diagram of the image sharing system according to an embodiment of the present invention;

FIGS. 5A and 5B are diagrams illustrating examples of page data according to an embodiment of the present invention;

FIGS. 6A and 6B are diagrams for describing image processing of a whiteboard image according to an embodiment of the present invention;

FIG. 7 is a sequence diagram of an example of operations by the image sharing system according to an embodiment of the present invention;

FIG. 8 is a diagram illustrating an example of a display screen of the terminal, when selecting an image to be uploaded, according to an embodiment of the present invention;

FIG. 9 is a sequence diagram of operations when the terminal uploads an image after compressing the image, according to an embodiment of the present invention;

FIG. 10 is a sequence diagram of operations when the terminal uploads an image without compressing the image, according to an embodiment of the present invention;

FIG. 11 is a flowchart of an upload process by the terminal, according to an embodiment of the present invention;

FIG. 12 is a flowchart of an image conversion process by an image converting unit, according to an embodiment of the present invention;

FIGS. 13A through 13C are diagrams for describing an example of the image conversion process according to an embodiment of the present invention; and

FIG. 14 is a diagram illustrating an example of a description of vector information according to an embodiment of the present invention.

### DETAILED DESCRIPTION OF THE PREFERRED EMBODIMENTS

In the related art, the consumption amount of the bandwidth of a network is reduced by decreasing the resolution of the data being sent to a display device; however, the displayed data is hard to view because the resolution is low. Furthermore, when the resolution is increased in a case where the bandwidth of the network is narrow, a long time is required to transmit the data.

A problem to be solved by an embodiment of the present invention is to mitigate the decrease in the resolution of the image data to be sent to an external device, while mitigating the consumption of the bandwidth of the network.

Embodiments of the present invention will be described by referring to the accompanying drawings.

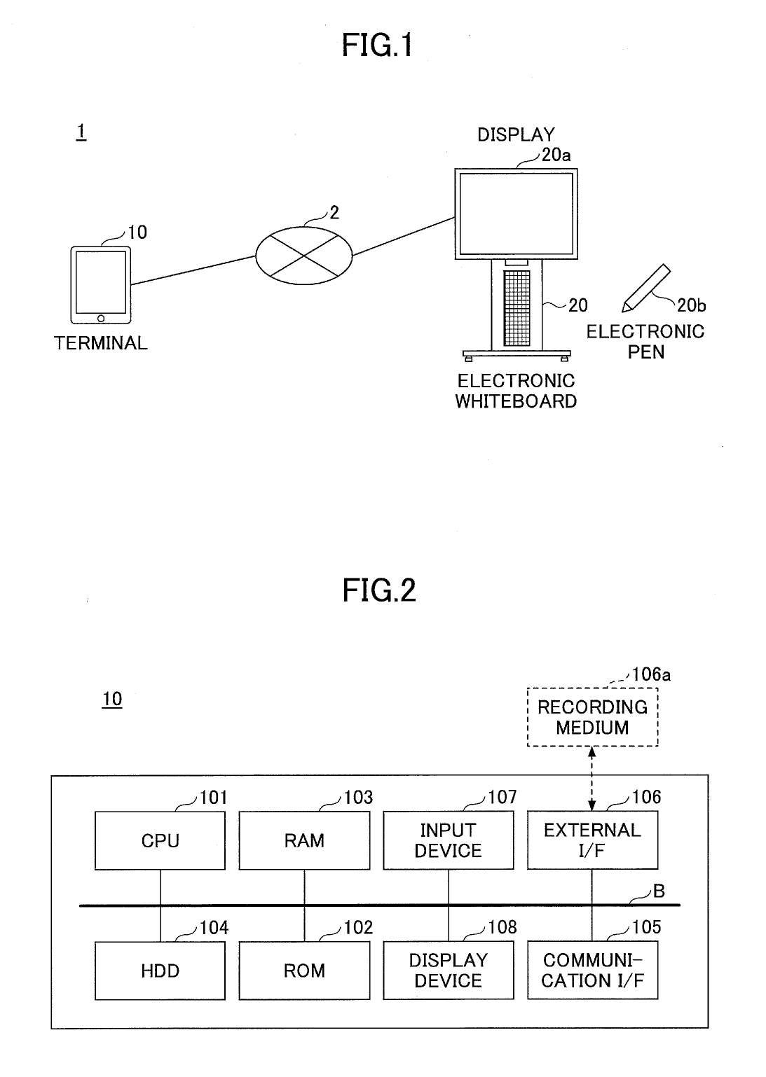

FIG. 1 is a diagram illustrating the entire configuration of an image sharing system 1 according to an embodiment of the present invention. The image sharing system 1 includes at least one terminal 10 (information processing apparatus) and at least one electronic whiteboard 20 (display device, electronic blackboard, or Interactive Whiteboard (IWB)). The terminal 10 and the electronic whiteboard 20 are communicatively connected to each other via a communication network 2 such as a wireless local area network (LAN), LAN, the Internet, and a mobile phone communication network, etc.

The terminal 10 is, for example, an information processing apparatus such as a tablet and a notebook personal computer (PC). The terminal 10 may be a terminal capable of supplying image frames, such as a desktop PC, a tablet PC, a personal digital assistant (PDA), a digital video camera, a digital camera, and a game console, etc.

The terminal 10 uploads an image stored in a storage device inside the terminal 10 or in an external storage device connected to the terminal 10, to the electronic whiteboard 20, and causes the electronic whiteboard 20 to display the image.

When the terminal 10 uploads an image to the electronic whiteboard 20, the terminal 10 extracts plurality of vertices of objects such as figures and characters, etc., and lines connecting the plurality of vertices, from the image that is a raster image. The terminal 10 converts the raster image into vector information expressed by information of the extracted plurality of vertices and lines, and sends the vector information to the electronic whiteboard 20.

The user inputs operation information such as strokes to the terminal 10 by using a finger, an electronic pen, and a mouse, etc. The terminal 10 sends the input operation information to the electronic whiteboard 20, and causes the operation information to be applied to an image displayed on the electronic whiteboard 20. Accordingly, the user is able to draw characters and figures, etc., on the screen of the electronic whiteboard 20, by operations at the terminal 10.

The terminal 10 receives, from the electronic whiteboard 20, an image being displayed at the electronic whiteboard 20, and displays the received image.

The electronic whiteboard 20 is an image processing apparatus that displays an image received from the terminal 10, on a screen.

The electronic whiteboard 20 draws images on the screen, based on operation information such as strokes received from the terminal 10.

The electronic whiteboard 20 is provided with a display 20a and an electronic pen 20b. The electronic whiteboard 20 is able to display, on the display 20a, an image drawn by an event caused by the electronic pen 20b (the tip of the electronic pen 20b or the nib of the electronic pen 20b touches and strokes the electronic whiteboard 20). Note that the image displayed on the display 20a may be changed based on an event that is caused not only by the electronic pen 20b but also by the hand (finger) of the user (a gesture of enlarging the image, reducing the image, and turning a page, etc.).

The electronic whiteboard 20 compresses the data of the image displayed on the screen of the display 20a, and distributes the compressed image as a video (moving image) to each terminal 10. Accordingly, the terminals 10 are able to share the image displayed on the electronic whiteboard 20 in a real-time manner.

Note that in the present embodiment, an electronic whiteboard (electronic blackboard) is described as an example of an image processing apparatus; however, the image processing apparatus is not so limited. Other examples of the image processing apparatus are an electronic signage (digital signage), a telestrator used for sports and weather forecasts, etc., or a remote image (video) diagnostic device, etc.

FIG. 2 is a hardware block diagram of the terminal 10 according to an embodiment of the present invention.

The terminal 10 includes a Central Processing Unit (CPU) 101, a Read-Only Memory (ROM) 102, a RAM (Random Access Memory) 103, a Hard Disk Drive (HDD) 104, a communication interface (I/F) 105, an external I/F 106, an input device 107, and a display device 108, which are interconnected by a bus B.

The CPU 106 is an arithmetic device for controlling the entire terminal 10 and realizing functions of the terminal 10, by loading the programs and data from the storage devices such as the ROM 102 into the RAM 103, and executing processes.

The ROM 102 is a non-volatile semiconductor memory (storage device) that can store programs and data even after the power is turned off. The ROM 102 stores programs and data such as a Basic Input/Output System (BIOS) and Operating System (OS) settings, etc.

The RAM 103 is a volatile semiconductor memory (storage device) for temporarily storing programs and data.

The HDD 104 stores data such an OS and application programs providing various functions.

Note that the terminal 10 may use a secondary storage device such as a solid state drive (SSD) instead of the HDD 104.

The communication I/F 105 performs communication conforming to Ethernet standards (registered trademark).

The external I/F 106 is an interface between the terminal 10 and an external device. An example of the external device is a recording medium 106a. The recording medium 106a stores programs for realizing the embodiments of the present invention. Accordingly, the terminal 10 is able to read and/or write in the recording medium 106a via the external I/F 106.

An example of the recording medium 106a is a Secure Digital (SD) memory card. The recording medium 106a may also be a Universal Serial Bus (USB) memory, a Digital Versatile Disc (DVD), a Compact Disc (CD), and a flexible disk.

Programs for realizing the embodiments of the present invention are stored, for example, in the recording medium 106a, and installed in the HDD 104 via the external I/F 106. When the program is downloaded from a network, the program is installed in the HDD 104 via the communication I/F 105.

The input device 107 is an interface for inputting various kinds of information to the terminal 10. The display device 108 is for displaying various kinds of information included in the terminal 10.

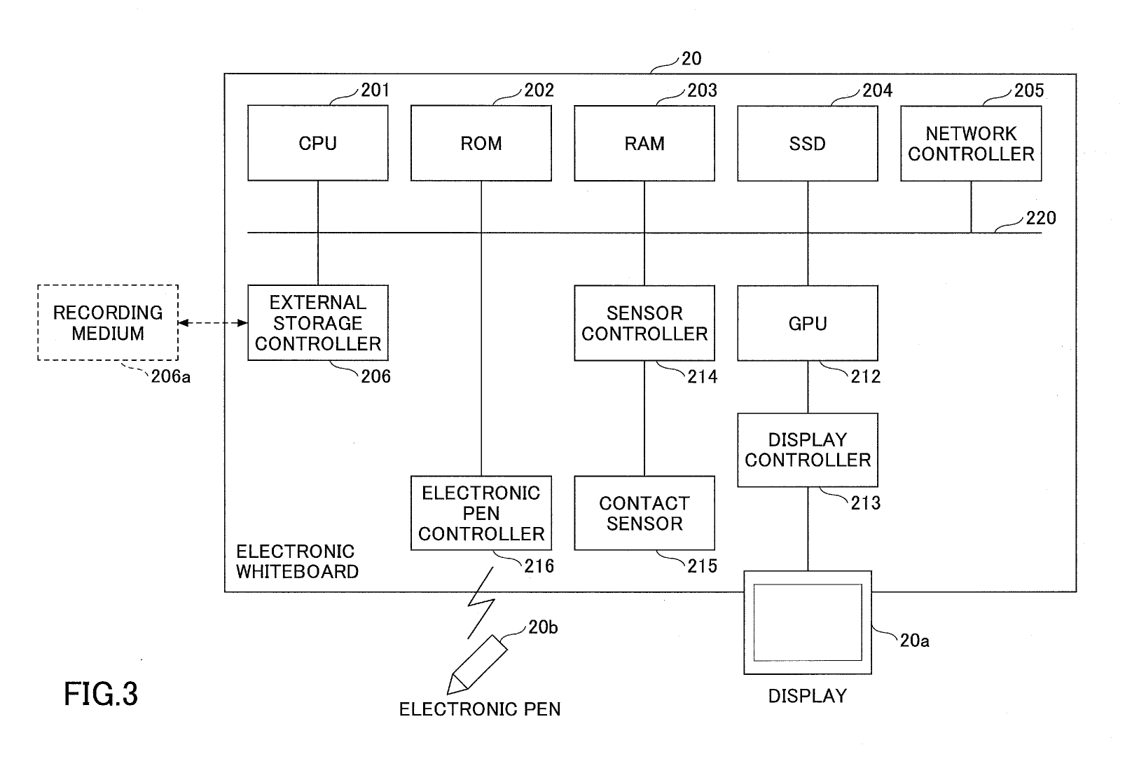

FIG. 3 is a hardware block diagram of the electronic whiteboard 20 according to an embodiment of the present invention.

As illustrated in FIG. 3, the electronic whiteboard 20 includes a CPU 201 for controlling the operations of the entire electronic whiteboard 20, a ROM 202 storing programs used for driving the CPU 201 such as an Initial Program Loader (IPL), a RAM 203 used as a work area of the CPU 201, an SSD 204 for storing various kinds of data such as programs for the electronic whiteboard 20, a network controller 205 for controlling communication with the communication network 2, and an external storage controller 206 for controlling communication with a recording medium 206a such as a USB memory.

Furthermore, the electronic whiteboard 20 includes a Graphics Processing Unit (GPU) 212 exclusively used for handling graphics, and a display controller 213 for controlling and managing the screen display for outputting output images from the GPU 212 to the display 20a.

Furthermore, the electronic whiteboard 20 includes a sensor controller 214 for controlling processes by a contact sensor 215, and the contact sensor 215 for detecting that the electronic pen 20b or a hand H of the user has contacted the display 20a. The contact sensor 215 inputs coordinates and detects coordinates by an infrared ray intercepting method. In the method of inputting coordinates and detecting coordinates, two light receiving/emitting devices (not illustrated), which are disposed on both ends at the top side of the display 20a, emit a plurality of infrared rays parallel to the display 20a. The infrared rays are reflected by reflection members provided around the display 20a, and the light receiving element receives light that returns along the same light path as the light path of the emitted light. The contact sensor 215 outputs identification information (ID) of the infrared rays emitted by the two light receiving/emitting devices blocked by an object to the sensor controller 214, and the sensor controller 214 identifies the coordinate position that is the contact position of the object. Note that all of the IDs described below are examples of identification information.

Furthermore, the contact sensor 215 is not limited to an infrared ray intercepting method. Various kinds of detecting units may be used, such as a touch panel of an electrostatic capacitance method for identifying the contact position by detecting changes in the electrostatic capacitance, a touch panel of a resistive method for identifying the contact position according to changes in the voltages of two resistance films facing each other, and a touch panel of an electromagnetic induction method for identifying the contact position by detecting electromagnetic induction that occurs as the contact object contacts the display unit.

The electronic whiteboard 20 is includes an electronic pen controller 216. The electronic pen controller 216 communicates with the electronic pen 20b to determine whether the tip of the electronic pen 20b or the nib of the electronic pen 20b has touched the display 20a. Note that the electronic pen controller 216 may not only detect the tip and the nib of the electronic pen 20b, but may also detect the part of the electronic pen 20b held by the user or other parts of the electronic pen 20b, to determine whether the electronic pen 20b is touching the display 20a.

Furthermore, the electronic whiteboard 20 includes a bus line 220 such as an address bus or a data bus, etc., for electrically connecting the CPU 201, the ROM 202, the RAM 203, the SSD 204, the network controller 205, the external storage controller 206, the GPU 212, the sensor controller 214, and the electronic pen controller 216.

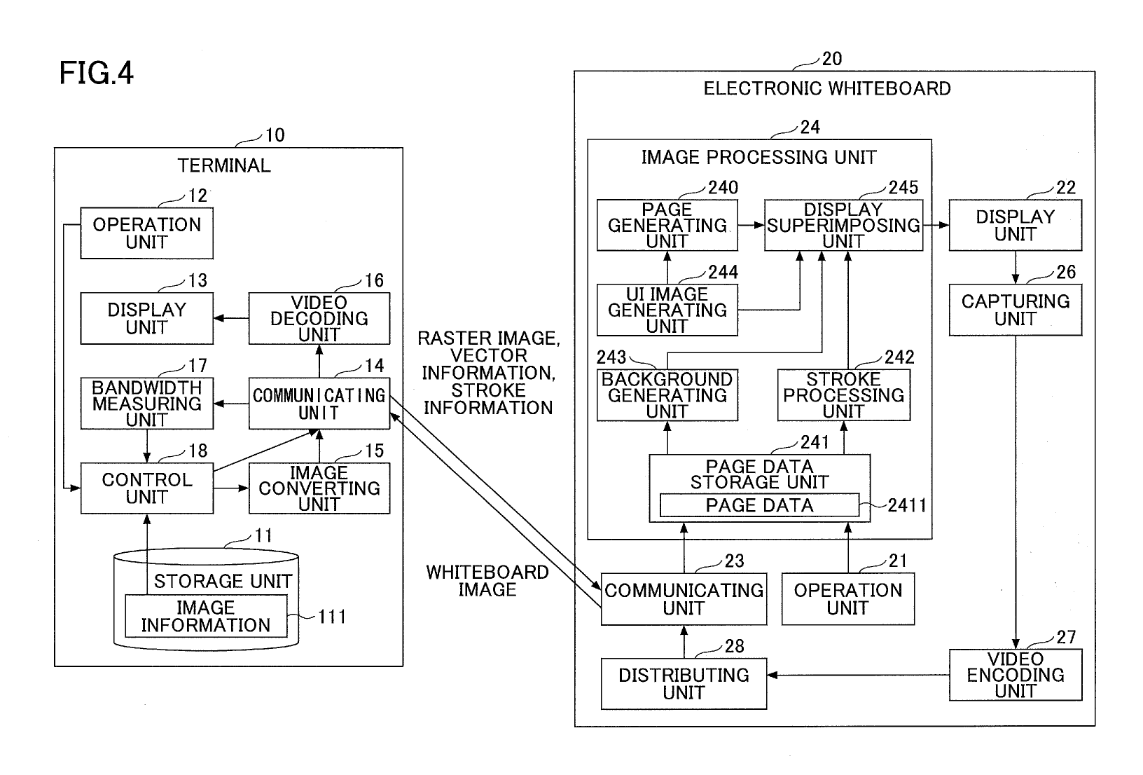

FIG. 4 is a functional block diagram of the image sharing system 1 according to an embodiment of the present invention. The terminal 10 includes a storage unit 11, an operation unit 12, a display unit 13, a communicating unit 14, an image converting unit 15, a video decoding unit 16, a bandwidth measuring unit 17, and a control unit 18. These units are realized by processes that the CPU 101 of the terminal 10 is caused to execute by one or more programs installed in the terminal 10.

The storage unit 11 stores image information 111. The image information 111 is data of images to be displayed on the electronic whiteboard 20. The images are raster images of, for example, the Joint Photographic Experts Group (JPEG) and Portable Network Graphics (PNG). Note that a raster image is image information expressed by an assembly of pixels having color information.

The operation unit 12 accepts an operation, which is input by the user with the use of the input device 107, for selecting an image to be displayed by the electronic whiteboard 20, and a stroke operation, which is manually input on the screen of the terminal (for example, an operation of moving a finger touching the touch panel screen or an operation of moving a cursor of a mouse while maintaining the clicked state), for drawing lines, etc., on the electronic whiteboard 20, etc.

The display unit 13 displays a screen for selecting an image to be displayed on the electronic whiteboard 20, and displays an electronic whiteboard image, etc., distributed from the electronic whiteboard 20, on the screen of the display device 108.

The communicating unit 14 communicates with the electronic whiteboard 20.

The image converting unit 15 extracts a plurality of vertices of an object in the raster image and lines connecting the plurality of vertices, and performs an image conversion process of converting the raster image into vector information. Note that details of the image conversion process are described below.

The video decoding unit 16 decodes the video data distributed from the electronic whiteboard 20.

The bandwidth measuring unit 17 measures the bandwidth of a network between the terminal 10 and the electronic whiteboard 20, according to instructions from the control unit 18. The bandwidth of a network is measured, for example, by using a ping command.

The control unit 18 displays, on the display unit 13, a video of electronic whiteboard images distributed from the electronic whiteboard 20 and decoded at the video decoding unit 16.

The control unit 18 performs an upload process of uploading a selected image to the electronic whiteboard 20, when the operation unit 12 accepts a selection of an image to be displayed on the electronic whiteboard 20. In the upload process, the control unit 18 determines whether to perform an image conversion process based on the bandwidth of the network measured by the bandwidth measuring unit 17. Note that details of the upload process are described below.

When the operation unit 12 accepts a stroke operation from the user, the control unit 18 sends, to the electronic whiteboard 20 via the communicating unit 14, information of the thickness and the color of the line set for the stroke operation, and stroke information including information of coordinates of the points that are touched (stroke data), arranged in the order of being touched on the screen by a finger or a stylus pen (touch pen) in the stroke operation.

The electronic whiteboard 20 includes an operation unit 21, a display unit 22, a communicating unit 23, an image processing unit 24, a capturing unit 26, a video encoding unit 27, and a distributing unit 28. These units are realized by processes that the CPU 201 of the electronic whiteboard 20 is caused to execute by one or more programs installed in the electronic whiteboard 20.

The operation unit 21 detects an event of an operation on the display 20a caused by a user on the display 20a (an operation of the tip of the electronic pen 20b or the nib of the electronic pen 20b pressing (touching) the display 20a, or an operation of the hand H of the user touching the display 20a, etc.).

The operation unit 21 detects a stroke operation, a user interface (UI) operation, and a gesture operation, based on the detected event.

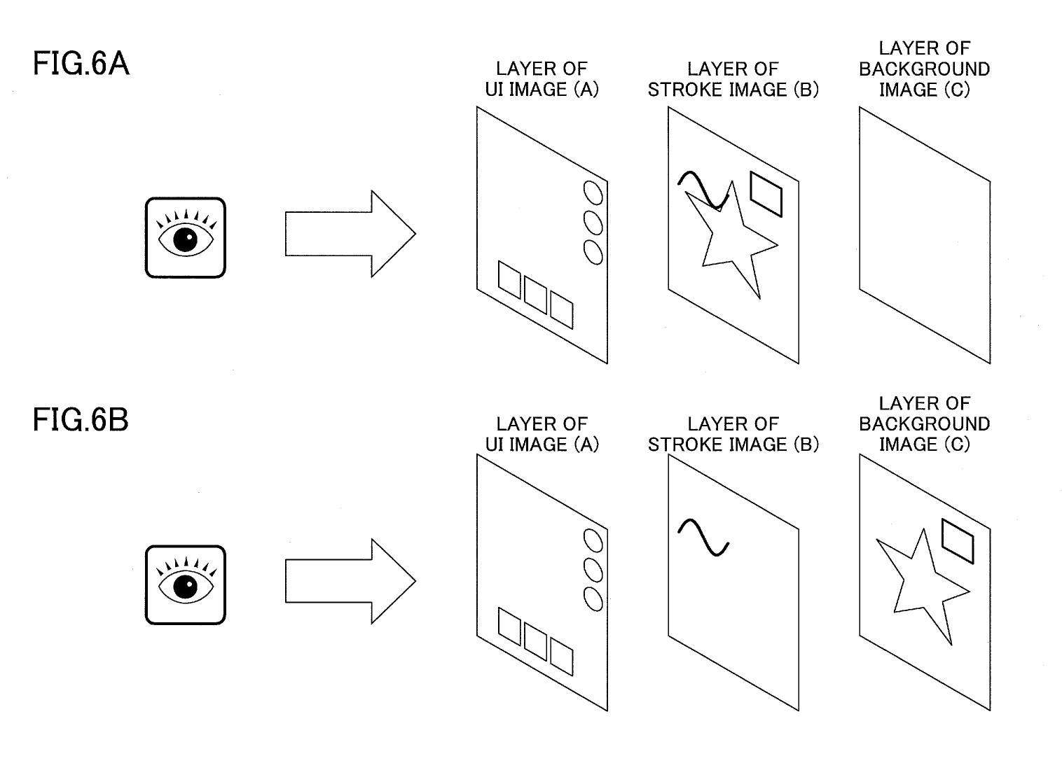

Here, a “stroke operation” is an event in which, for example, the user presses the display 20awith the electronic pen 20b, moves the electronic pen 20b in a pressed state, and finally releases the electronic pen 20b from the display 20a, when displaying a stroke image (B) illustrated in FIGS. 6A and 6B described below on the display 20a. By this stroke operation, for example, an alphabetical letter “S” and “T”, etc., is drawn on the display 20a.

A “UI operation” is an event in which the user presses a predetermined position with the electronic pen 20b or the user's hand H, when a UI image (A) illustrated in FIGS. 6A and 6B is displayed on the display 20a. By this UI operation, for example, the color and the thickness (width), etc., of the line drawn by the stroke operation, are set.

A “gesture operation” is an event in which the user touches the display 20a with his hand H and moves his hand H on the display 20a, when the stroke image (B) illustrated in FIGS. 6A and 6B described below is displayed on the display 20a. By this gesture operation, for example, as the user moves his hand H in a state where his hand H is touching the display 20a, the image can be enlarged (or reduced), the display area can be changed, or the page can be turned, etc.

The display unit 22 displays a whiteboard image on the display 20a screen.

The communicating unit 23 communicates with each terminal 10.

The image processing unit 24 performs image processing based on raster information, vector information, and stroke information received from the terminal 10 via the communicating unit 23, and stroke operations from the operation unit 21, draws an image on the whiteboard image, and causes the display unit 22 to display the image.

The image processing unit 24 includes a page generating unit 240, a page data storage unit 241, a stroke processing unit 242, a background generating unit 243, a UI image generating unit 244, and a display superimposing unit 245.

The page generating unit 240 creates a new page when an image is uploaded from the terminal 10, and displays the page as a whiteboard image on the display unit 22.

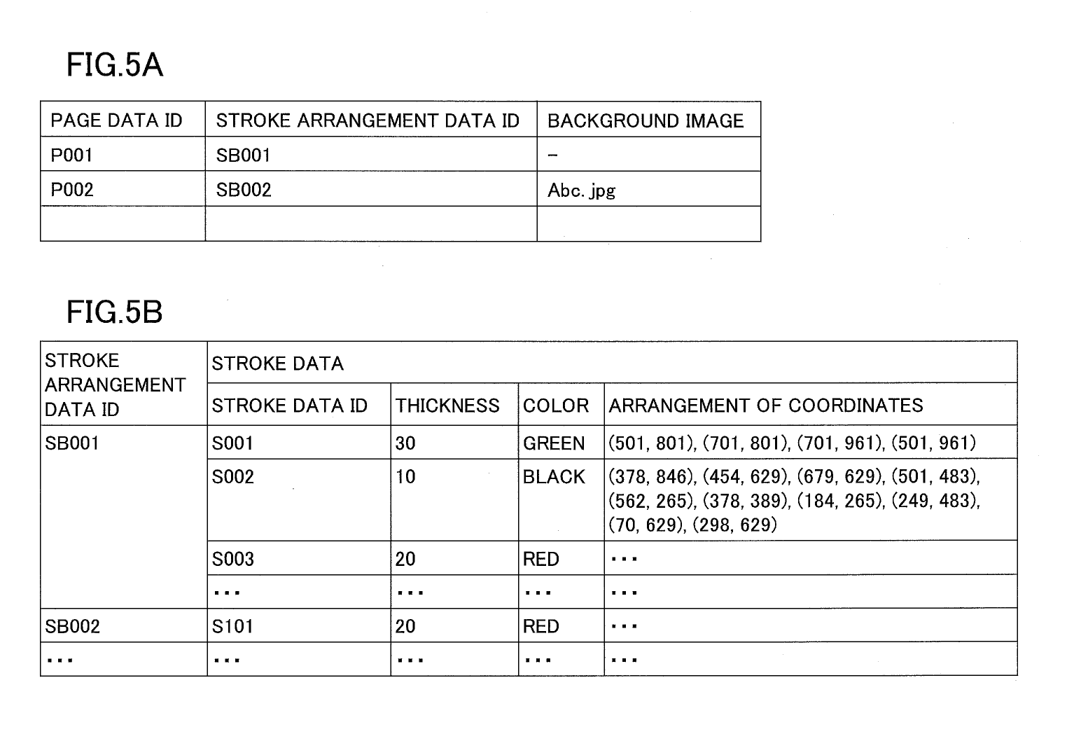

The page data storage unit 241 stores page data 2411 as illustrated in FIGS. 5A and 5B. FIG. 5A is a conceptual diagram illustrating the page data 2411 according to an embodiment of the present invention. The page data 2411 is data (stroke arrangement data (each stroke data item) and a background image) corresponding to one page displayed on the display 20a.

As illustrated in FIG. 5A, the page data 2411 includes the data items of a page data ID, a stroke arrangement data ID, and a background image ID. The page data ID is an ID for identifying any one page to be displayed on the screen of the electronic whiteboard 20.

The stroke arrangement data ID is an ID for identifying the stroke arrangement data. The background image ID is an ID for identifying the background image. The stroke arrangement data is data for displaying the stroke image (B) illustrated in in FIGS. 6A and 6B on the display 20a. The background image is data for displaying the background image (C) illustrated in FIGS. 6A and 6B described below on the display 20a.

By the above-described page data 2411, for example, when the user draws an alphabetical letter “S” with the electronic pen 20b, the letter is traversable (drawn by one stroke), and therefore a single alphabetical letter “S” can be indicated by a single stroke data ID. However, when the user draws an alphabetical letter “T” with the electronic pen 20b, the letter is drawn by two strokes, and therefore a single alphabetical letter “T” is indicated by two stroke data IDs.

FIG. 5B is a conceptual diagram illustrating the stroke arrangement data in the page data 2411 according to an embodiment of the present invention. As illustrated in FIG. 5B, each stroke arrangement data item includes one or more stroke data items. Each stroke data item includes a stroke data ID for identifying the corresponding stroke data item, a thickness, a color, and an arrangement of coordinates. For example, in a case where the stroke data is based on a stroke operation from the operation unit 21, or the stroke data is included in stroke information received from the terminal 10, when the user draws the alphabetical letter “S” with the electronic pen 20b, etc., the letter traversable; however, a plurality of passing points are passed to finish drawing “S”, and therefore the arrangement of coordinates indicates the coordinates of the plurality of passing points.

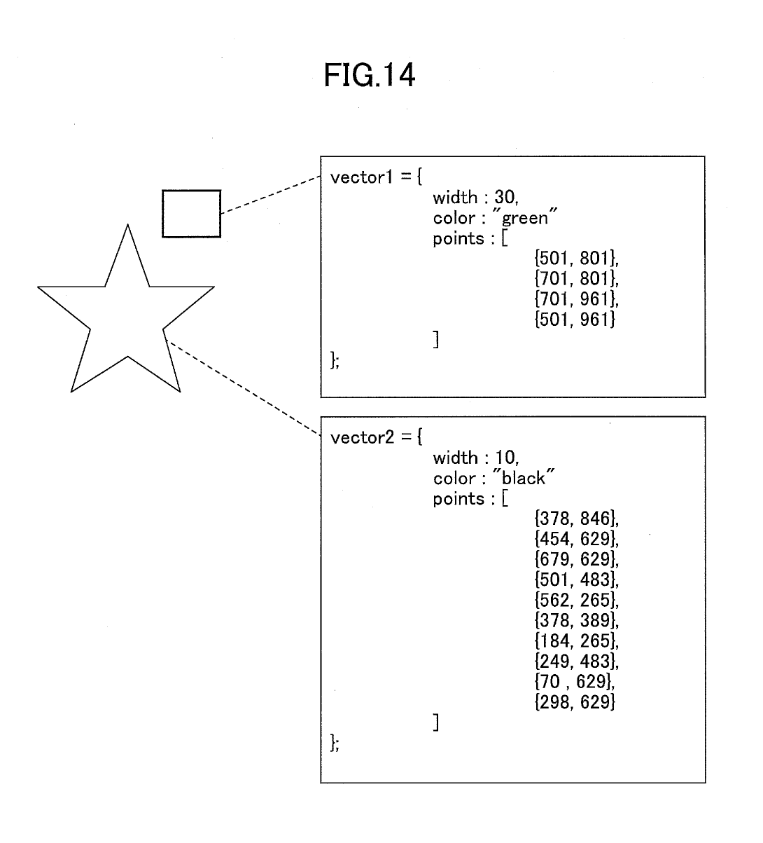

Furthermore, in a case where the stroke data is included in vector information received from the terminal 10, the thickness of the line connecting a plurality of vertices of the object in the raster image, the color of the line, and coordinates of the plurality of vertices are recorded. The coordinates of the plurality of vertices are recorded in an order of being connected by the line. The stroke data having a stroke data ID of “S001” in FIG. 5B is an example of data based on vector information (vector1) illustrated in FIG. 14 described below, received from the terminal 10. The stroke data having a stroke data ID of “S002” is an example of data based on vector information (vector2) illustrated in FIG. 14 described below, received from the terminal 10.

The page data storage unit 241 stores, in the stroke arrangement data of the page data 2411, the vector information and the stroke information received from the terminal 10 via the communicating unit 23, and the stroke data that is information of the thickness, the color, and the arrangement of coordinates, included in the stroke operation from the operation unit 21.

The page data storage unit 241 stores the raster image received from the terminal 10 via the communicating unit 23, in the item of the background image in the page data 2411.

Next, referring to FIGS. 6A and 6B, a description is given of image processing by the image processing unit 24. FIGS. 6A and 6B are diagrams for describing image processing of a whiteboard image by the image processing unit 24 according to an embodiment of the present invention. FIG. 6A is a diagram illustrating an example of displaying an image uploaded by vector information from the terminal 10. FIG. 6B is a diagram illustrating an example of displaying an image uploaded by raster image from the terminal 10.

The stroke processing unit 242 draws, on a whiteboard image, a line connecting a plurality of coordinates in the stored order, by the thickness and the color stored in the stroke arrangement data of the page data 2411. Furthermore, the stroke processing unit 242 deletes a drawn image and edits a drawn image. The image according to the stroke operation, etc., corresponds to the stroke image (B) illustrated in FIGS. 6A and 6B.

The background generating unit 243 outputs the raster image stored in the background image of the page data 2411, to the display superimposing unit 245. Note that the raster image corresponds to the background image (C) illustrated in FIGS. 6A and 6B.

The UI image generating unit 244 generates a user interface (UI) image set in advance in the electronic whiteboard 20. The UI image corresponds to the UI image (A) illustrated in FIGS. 6A and 6B.

The display superimposing unit 245 superimposes the stroke image (B) from the stroke processing unit 242, the UI image (A) from the UI image generating unit 244, and the background image (C) from the background generating unit 243, to form the whiteboard image. Accordingly, as illustrated in FIGS. 6A and 6B, the layers of the UI image (A), the stroke image (B), and the background image (C) are superimposed in the stated order as viewed from the user, and displayed on the display unit 22.

The capturing unit 26 captures the whiteboard images displayed on the display unit 22, at predetermined intervals.

The video encoding unit 27 encodes the information of the whiteboard images captured at predetermined intervals by the capturing unit 26, as a video. Note that as the method of the encoding the video may be, for example, MPEG (Moving Picture Experts Group) and Motion Joint Photographic Experts Group (JPEG), etc.

The distributing unit 28 distributes the video encoded by the video encoding unit 27, to each terminal 10.

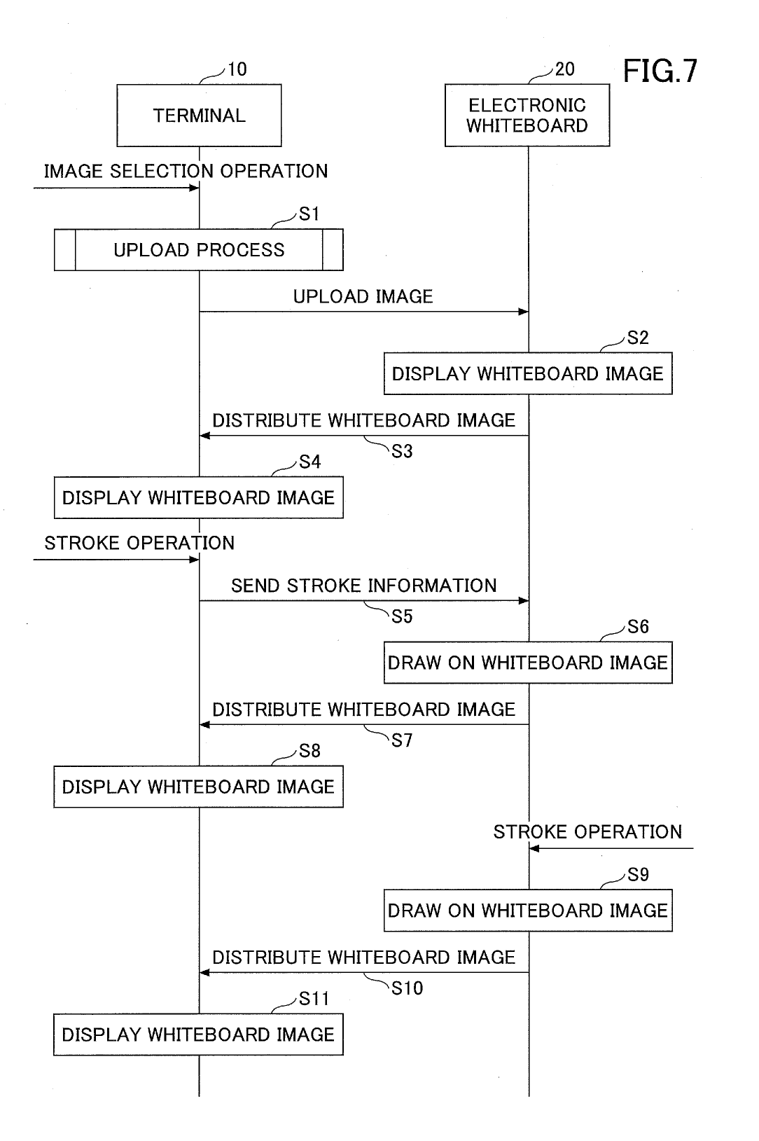

Next, referring to FIG. 7, a description is given of operations by the image sharing system 1 according to an embodiment. FIG. 7 is a sequence diagram of an example of operations by the image sharing system 1 according to an embodiment of the present invention.

The terminal 10 uploads an image selected by a user, to the electronic whiteboard 20 (step S1).

The electronic whiteboard 20 displays a whiteboard image including the uploaded image as the background (step S2).

The electronic whiteboard 20 captures the whiteboard image, encodes the captured whiteboard image as a video, and distributes the whiteboard image to the terminal 10 (step S3).

The terminal 10 displays the distributed whiteboard image as a video (step S4).

When the terminal 10 accepts a stroke operation from the user, the terminal 10 sends stroke information to the electronic whiteboard 20 (step S5).

The electronic whiteboard 20 draws an image on the whiteboard image based on the stroke information, and displays the image (step S6).

The electronic whiteboard 20 captures the whiteboard image, encodes the captured whiteboard image as a video, and distributes the whiteboard image to the terminal 10 (step S7).

The terminal 10 displays the distributed whiteboard image as a video (step S8).

When the electronic whiteboard 20 accepts a stroke operation from the user, the electronic whiteboard 20 draws an image on the whiteboard image based on the information of the stroke operation, and displays the image (step S9).

The electronic whiteboard 20 captures the whiteboard image, encodes the captured whiteboard image as a video, and distributes the whiteboard image to the terminal 10 (step S10).

The terminal 10 displays the distributed whiteboard image as a video (step S11).

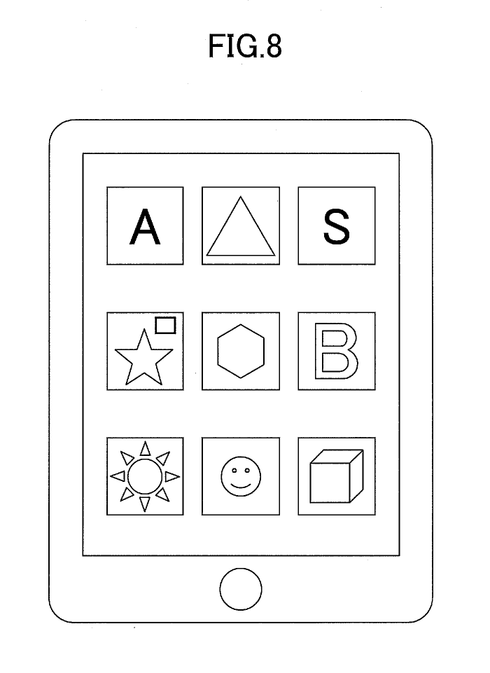

Next, referring to FIG. 8, a description is given of a display screen of the terminal 10, when the user selects the image to be uploaded to the electronic whiteboard 20 in step S1 of FIG. 7. FIG. 8 is a diagram illustrating an example of a display screen of the terminal, when selecting an image to be uploaded, according to an embodiment of the present invention. The terminal 10 displays a list of images on a menu screen as illustrated in FIG. 8, in response to an operation from the user. The user selects an image by a tap operation, etc., in the menu screen. The terminal 10 uploads the image selected by the user to the electronic whiteboard 20.

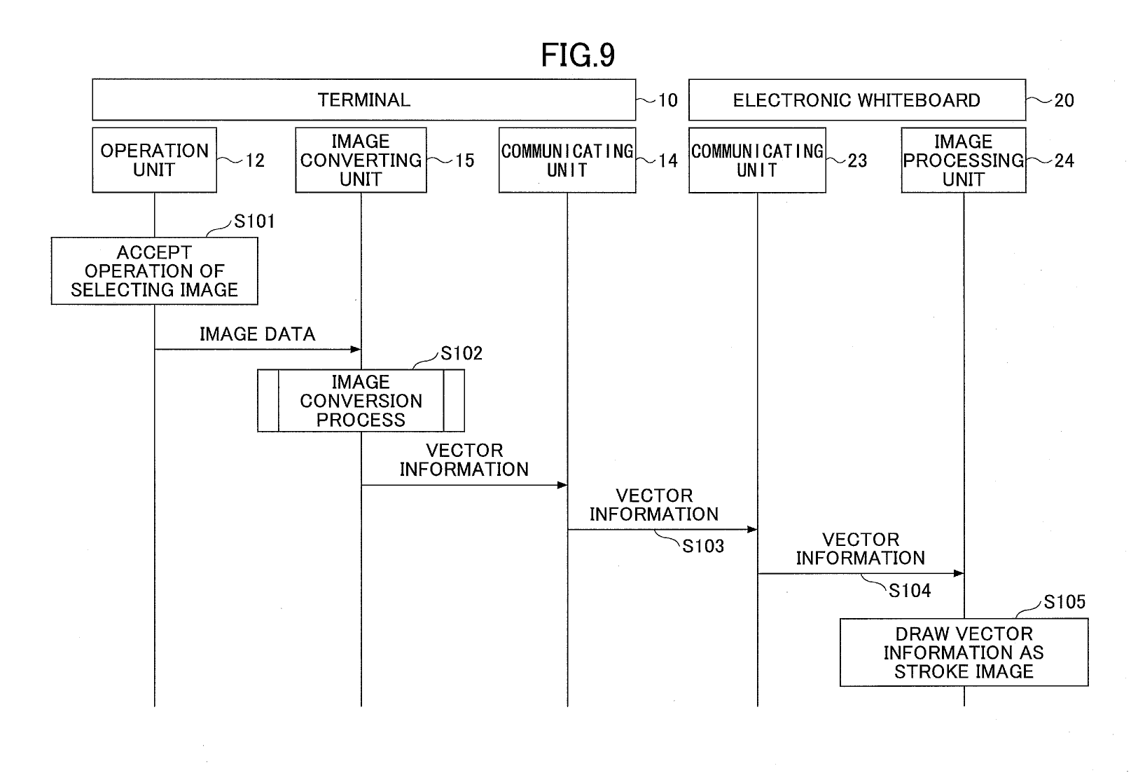

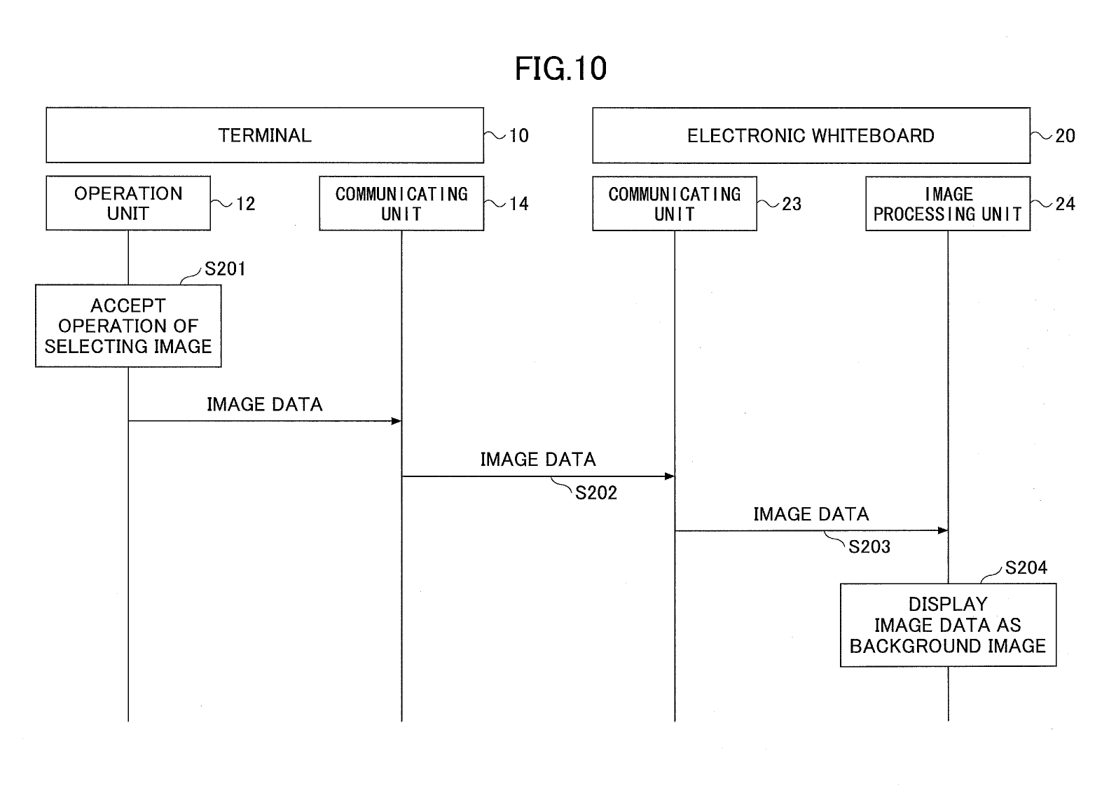

Next, referring to FIGS. 9 and 10, a description is given of operations of the upload process of step S1 in FIG. 7.

FIG. 9 is a sequence diagram of operations when the terminal 10 uploads the image after compressing the image, according to an embodiment of the present invention.

The operation unit 21 of the terminal 10 accepts an operation of selecting an image (step S101).

The image converting unit 15 performs an image conversion process of converting the selected image from a raster image into vector information (step S102).

The communicating unit 14 sends the vector information converted from the raster image, to the electronic whiteboard 20 (step S103).

The communicating unit 23 of the electronic whiteboard 20 receives the vector information (step S104).

The image processing unit 24 processes the received vector information by the stroke processing unit 242, in the same manner as processing a stroke operation, and draws the vector information as a stroke image on the whiteboard image (step S105).

FIG. 10 is a sequence diagram of operations when the terminal 10 uploads the image without compressing the image, according to an embodiment of the present invention.

The operation unit 21 of the terminal 10 accepts an operation of selecting an image (step S201).

The communicating unit 14 sends the selected image to the electronic whiteboard 20 (step S202).

The communicating unit 23 of the electronic whiteboard 20 receives the image (step S203).

The image processing unit 24 displays a whiteboard image including the received image data as the background image (step S204).

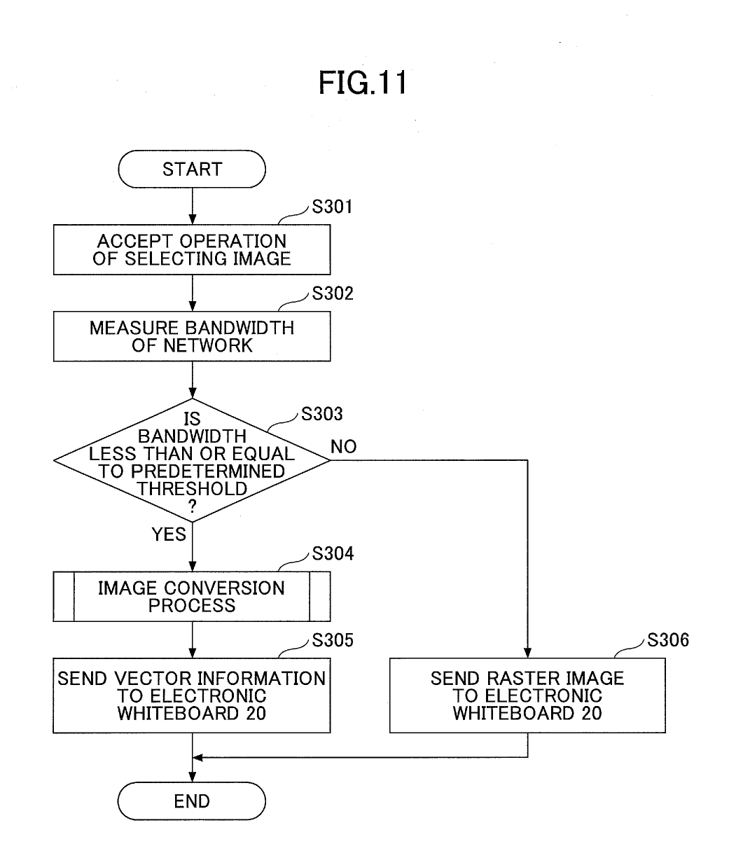

Next, referring to FIG. 11, a description is given of details of the upload process of uploading an image to the electronic whiteboard 20 by the control unit 18. FIG. 11 is a flowchart of an upload process by the terminal 10, according to an embodiment of the present invention.

First, the terminal 10 accepts an operation of selecting an image from the user (step S301).

The terminal 10 measures the bandwidth of the network (step S302), and determines whether the bandwidth is less than or equal to a predetermined threshold (step S303).

When the bandwidth is less than or equal to a predetermined threshold (YES in step S303), the terminal 10 performs an image conversion process of converting the selected image from a raster image into vector information (step S304), and sends the vector information to the electronic whiteboard 20 (step S305).

When the bandwidth is not less than or equal to a predetermined threshold (NO in step S303), the terminal 10 sends the raster image of the selected image to the electronic whiteboard 20 (step S306).

Note that the threshold of the bandwidth in step 5303 may be set by the user. In this case, the operation unit 12 may accept an operation of setting a threshold from the user, and the control unit 18 may make the determination based on the set threshold. Accordingly, the user is able to set a threshold of a bandwidth for determining whether to prioritize the mitigation of the consumption amount of the bandwidth by performing an image conversion process or to prioritize the image quality without performing an image conversion process, according to the network environment, etc.

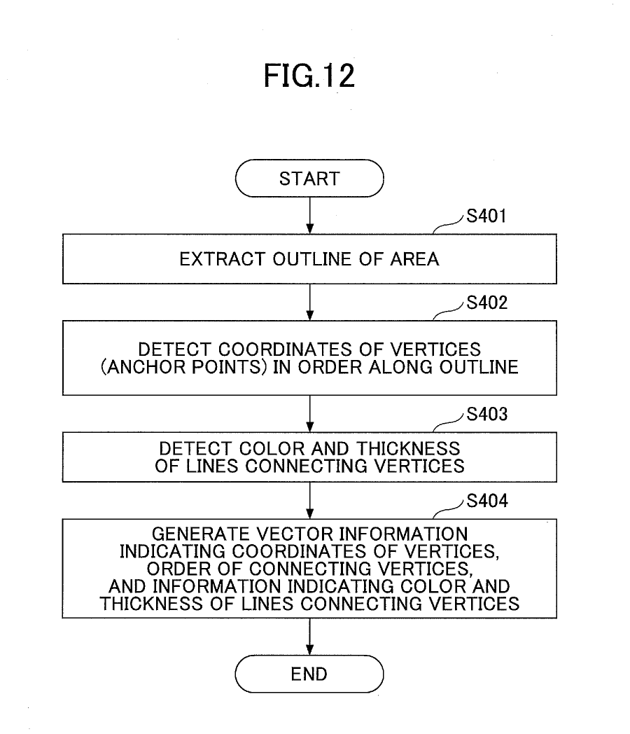

Next, referring to FIG. 12, a description is given of details of the image conversion process of converting the raster image into the vector information by the image converting unit 15, in step S304 of FIG. 11. FIG. 12 is a flowchart of an image conversion process by the image converting unit 15, according to an embodiment of the present invention.

First, the image converting unit 15 extracts outlines of an object in the raster image, from the selected raster image (step S401). Note that the outlines are extracted by a known outline detection method such as a relaxation method, a zero-crossing method, and a Canny method, etc.

The image converting unit 15 detects the coordinates of the vertices in the extracted outlines (anchor points, feature points, and corners), in an order along the outlines (step S402). Note that the vertices are detected by a known corner detecting method such as the Harris/Plessey method, the Kanade-Lucas-Tomasi (KLT) method, and the principal curvature method, etc.

The image converting unit 15 detects the color and the thickness of the line connecting the vertices (step S403).

The image converting unit 15 generates vector information indicating the coordinates of the vertices, the order in which the vertices are detected along the outline (the order in which the vertices are connected by a line when drawing an image), and information of the color and the thickness of the line connecting the vertices (step S404).

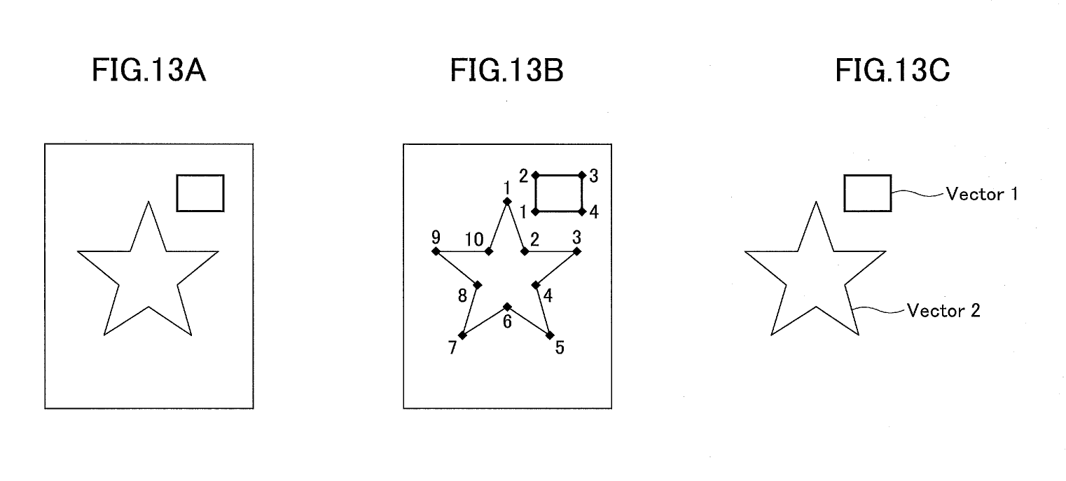

Next, referring to FIGS. 13A through 14, a description is given of an example of the image conversion process of FIG. 12. FIGS. 13A through 13C are diagrams for describing an example of the image conversion process according to an embodiment of the present invention. FIG. 14 is a diagram illustrating an example of a description of vector information according to an embodiment of the present invention.

FIGS. 13A through 13C illustrate an example where the image selected by the user is an image including figures of a square shape and a star shape. First, as illustrated in FIG. 13A, in step S401 of FIG. 12, the image converting unit 15 extracts the outlines of the square shape and the star shape.

Next, as illustrated in FIG. 13B, in step S402 of FIG. 12, the image converting unit 15 detects the coordinates of the respective vertices of the square shape and the star shape, in an order along the outlines. The numbers indicated in FIG. 13B indicate an example of the order of detecting the vertices.

Next, as illustrated in FIG. 13C, in step S403 of FIG. 12, the image converting unit 15 detects the color and the thickness of the lines connecting the vertices of the square shape and the star shape.

Next, as illustrated in FIG. 14, in step S404 of FIG. 12, the image converting unit 15 generates vector information including information of the color and the thickness of the lines connecting the vertices, and the arrangement of coordinates of the vertices arranged in the order of being detected along the outlines (in the order of connecting the coordinates of the vertices when drawing the image), for each of the square shape and the star shape.

In the example of the description of vector information according to an embodiment in FIG. 14, in the vector information (vector1) corresponding to the figure of the square shape, the thickness (width) of the line connecting the vertices is 30 pixels, the color of the line connecting the vertices is green, and the order of the coordinates connecting the vertices is (501, 801), (701, 801), (701, 961), (501, 961) when the bottom left corner of the image is the origin.

In the example in FIG. 14, in the vector information (vector2) corresponding to the figure of the star shape, the thickness (width) of the line connecting the vertices is 10 pixels, the color of the line connecting the vertices is black, and the order of the coordinates connecting the vertices is (378, 846), (454, 629), (679, 629), (501, 483), (562, 265), (378, 389), (184, 265), (249, 483), (70, 629), (298, 629) when the bottom left corner of the image is the origin.

### EFFECTS

As described above, the terminal 10 according to the present embodiment converts the raster image into vector information that is information of lines connecting the vertices in the drawing and information of the coordinates of the vertices, and sends the vector information. The data size of the vector information is significantly smaller than the data size of the raster image, and therefore the consumption of the bandwidth of the network is reduced while maintaining the resolution of the image data.

Furthermore, the vector information according to an embodiment is information of coordinates of the vertices and lines connecting the vertices, and therefore the electronic whiteboard 20 is able to draw an image of the vector information on an electronic whiteboard image by the same process as the process performed for a stroke operation.

### MODIFIED EXAMPLE

In the above embodiments, the terminal 10 determines whether to perform an image conversion process according to the bandwidth of the network measured at the terminal 10. However, the operation unit 12 may accept a setting operation from the user and the control unit 18 may control whether to perform an image conversion process based on the setting. Accordingly, the user is able to select whether to prioritize the mitigation of the consumption amount of the bandwidth by performing an image conversion process or to prioritize the image quality without performing an image conversion process, according to the network environment, etc.

The control unit 18 may have the following configuration, instead of the configuration of determining whether the bandwidth is less than or equal to a predetermined threshold, in step S303 of FIG. 3. Specifically, the control unit 18 sends a raster image to the electronic whiteboard 20 by using the communicating unit 14. Then, the control unit 18 estimates the time required for sending the data of the raster image, and when the value of the estimated time is higher than or equal to a predetermined threshold, the control unit 18 performs the image conversion process. Alternatively, the control unit 18 may perform the image conversion process when the transmission of higher than or equal to a predetermined ratio of the data of the raster image is not completed within a predetermined time.

In the present embodiment, at least one terminal 10 and the electronic whiteboard 20 are connected; however, the image sharing system 1 according to the present embodiment is also applicable to a case where a plurality of terminals 10 are connected to each other or a plurality of electronic whiteboards 20 are connected to each other to share images.

The electronic whiteboard 20 may be implemented by installing a predetermined application program in an information processing apparatus such as a tablet and a notebook PC, etc. In this case, on the screen of the information processing apparatus, images uploaded from the terminal 10 and drawings based on a stroke operation of the terminal 10 may be displayed.

Note that the system configuration of the above embodiment is one example, and various examples of system configurations may be used according to the purpose and the object.

According to one embodiment of the present invention, an information processing apparatus is capable of mitigating the decrease in the resolution of the image data to be sent to an external device, while mitigating the consumption of the bandwidth of the network.

The information processing apparatus and the method for transmitting images are not limited to the specific embodiments described in the detailed description, and variations and modifications may be made without departing from the spirit and scope of the present invention.

What is claimed is:

1. An information processing apparatus comprising:
an image converter configured to extract a plurality of vertices of an object in a raster image and at least one line connecting the plurality of vertices, and to convert the raster image into vector information expressed by information of the plurality of vertices and the at least one line; and
a transmitter configured to transmit the vector information.

2. The information processing apparatus according to claim 1, wherein the transmitter transmits the vector information to an electronic whiteboard coupled to the information processing apparatus.

3. The information processing apparatus according to claim 1, wherein the vector information includes information of coordinates of the plurality of vertices, an order of connecting the plurality of vertices with the at least one line, a color of the at least one line, and a thickness of the at least one line.

4. The information processing apparatus according to claim 1, further comprising:
a bandwidth measurer configured to measure a bandwidth of a network; and
a controller configured to control whether to convert the raster image based on the bandwidth.

5. The information processing apparatus according to claim 4, further comprising:
an operation part configured to accept a setting of a threshold, wherein
the controller controls the raster image to be converted when the bandwidth is less than or equal to the threshold.

6. The information processing apparatus according to claim 1, further comprising:
an operation part configured to accept a setting; and
a controller configured to control whether to convert the raster image based on the setting.

7. A method for transmitting images executed by an information processing apparatus, the method comprising:
extracting a plurality of vertices of an object in a raster image and at least one line connecting the plurality of vertices;
converting the raster image into vector information expressed by information of the plurality of vertices and the at least one line; and
transmitting the vector information.
